(19) United States
(12) Patent Application Publication
(10) Pub. No.: US 2026/0194945 A1
(43) Pub. Date: Jul. 9, 2026

(54) PORTABLE ELECTRONIC DEVICE

(71) Applicant: Razer (Asia-Pacific) Pte. Ltd., Singapore (SG)

(72) Inventors: ChengYu CHENG, Taipei City (TW); FuMei WANG, Taipei City (TW); YiHsiang HUNG, Taipei City (TW)

(73) Assignee: Razer (Asia-Pacific) Pte. Ltd., Singapore (SG)

(21) Appl. No.: 19/132,443

(22) PCT Filed: Jan. 20, 2023
(86) PCT No.: PCT/SG2023/050044

§ 371 Date: May 23, 2025

(51) Int. Cl. G06F 1/20; G06F 1/16

(52) U.S. Cl. CPC G06F 1/206; G06F 1/1658; G06F 1/203

(57) ABSTRACT

There may be provided a portable electronic device which may include a housing partitioned into a component enclosure portion and a module bay portion. The portable electronic device may include a heat-generating component and a heat-dissipation arrangement disposed within the component enclosure portion of the housing. The heat-dissipation arrangement may include a thermal transfer body in thermal contact with the heat-generating component, a primary thermal conveyance duct, and an auxiliary thermal conveyance duct.

### TECHNICAL FIELD

Various embodiments generally relate to a portable electronic device. In particular, various embodiments generally relate to a portable electronic device which includes a cooling system for cooling one or more internal components.

### BACKGROUND

Overheating of portable electronic devices (e.g. laptops, handphone, etc.) is a problem faced by many consumers (i.e. users) of these portable electronic devices.

Moreover, as consumers appeal for more compact-sized versions of such portable electronic devices and/or for these portable electronic devices to be capable of performing at a higher level for longer periods of time, overheating of internal components of such portable electronic devices become an even more prevalent issue.

Accordingly, there may be a need for a portable electronic device with an efficient cooling system which addresses at least the above issues.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various embodiments are described with reference to the following drawings, in which:

FIG. 1 shows a schematic diagram of a portable electronic device, according to various embodiments;

FIG. 2A shows a schematic bottom view of a portable electronic device which includes a heat-dissipation arrangement, and a fan carriage module within a module bay portion of a housing of the portable electronic device, according to various embodiments;

FIG. 2B shows a schematic bottom view of the portable electronic device of FIG. 2A with a power source module within the module bay portion of the housing of the portable electronic device, according to various embodiments; and

FIG. 2C shows a schematic top view of the portable electronic device of FIG. 2A, according to various embodiments.

### DETAILED DESCRIPTION

It will be understood that the embodiments described below may be combined, for example, a part of one embodiment may be combined with a part of another embodiment.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

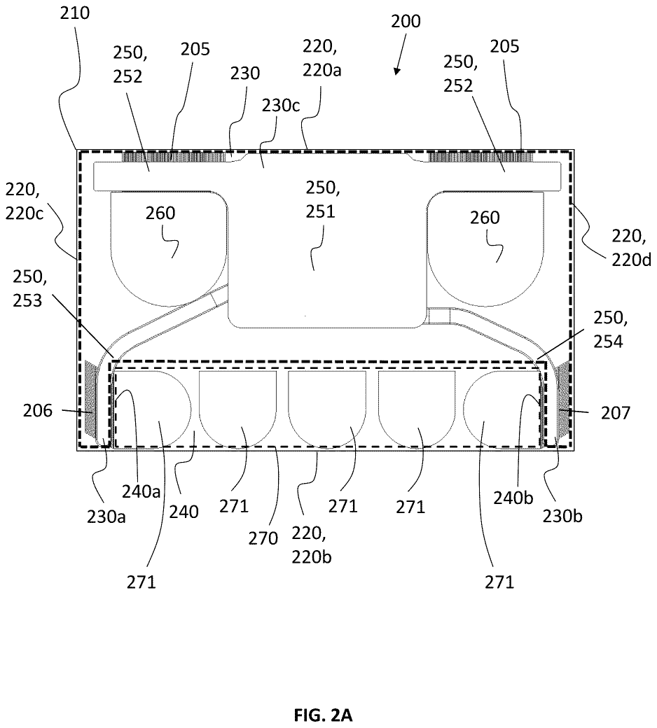

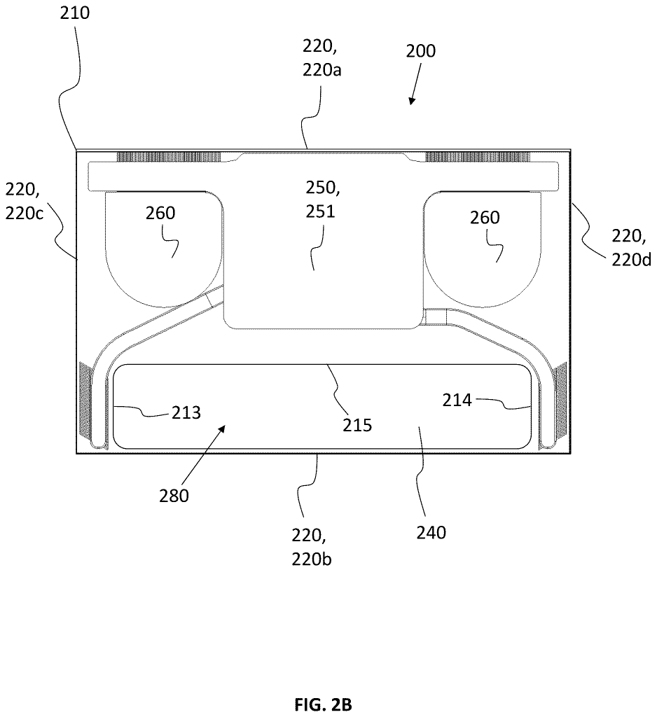

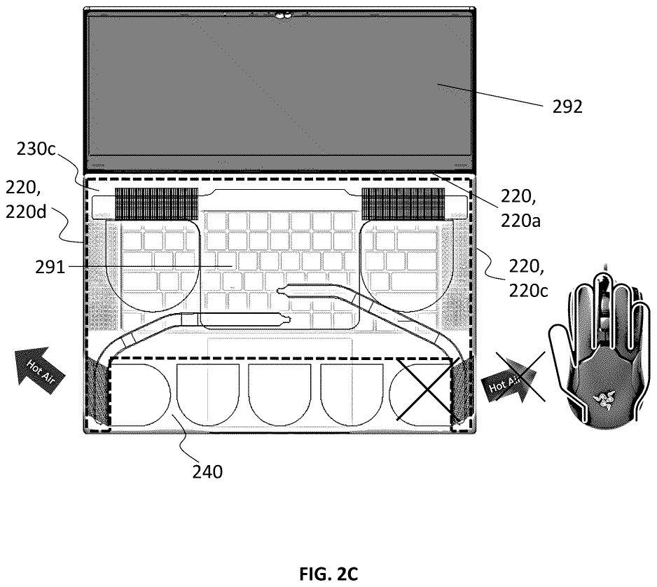

Various embodiments may provide a portable electronic device (e.g. laptop, notebook, portable personal computer, tablet, palmtop etc.) which may include a module receiving bay (e.g. module bay portion) configured to interchangeably receive a battery module (e.g. power source module) or a cooling module (e.g. fan carriage module) (shown in FIG. 2A and FIG. 2B).

The battery module may be inserted into the module bay portion of the portable electronic device, for example, when a user of the portable electronic device requires powering or operating the portable electronic device while the user is on the move and/or does not have access to a mains electricity.

The portable electronic device may include a power-receiving port (e.g. USB, USB-C, power connector socket, etc.) for receiving power from a mains electricity (e.g. wall power).

Accordingly, the cooling module may be inserted into the module bay portion in place of the battery module, while the portable electronic device is powered by a mains electricity. The cooling module may include a plurality of fans (e.g. auxiliary fan units). The plurality of fans of the cooling module may serve to provide enhanced or additional cooling to internal components (e.g. heat-generating components or electronics) of the portable electronic device, when the cooling module is inserted into the module bay portion. The enhanced or additional cooling provided by the plurality of fans of the cooling module may allow or enable the portable electronic device (e.g. Central Processing Unit and/or a Graphics Processing Unit of the portable electronic device) to perform at a higher level (i.e. which would generate more heat and thus require additional cooling). In other words, the cooling module may allow the portable electronic device to be pushed to a higher performance level.

According to various embodiments, a cooling system of the portable electronic device may include a heat-dissipation arrangement configured to efficiently direct heat away from internal components (e.g. heat-generating components or electronics) of the portable electronic device and/or out of the portable electronic device. The heat-dissipation arrangement may be a fixed/rigid component within (e.g. enclosed or encased within) the portable electronic device and may be in thermal contact with one or more internal components of the portable electronic device.

According to various embodiments, the heat-dissipation arrangement and the cooling module may cooperate with each other (e.g. may be arranged or disposed in a cooperative manner) to increase a rate at which heat may be expelled out of the portable electronic device. As such, the heat-dissipation arrangement and the cooling module may be part of or may together form the cooling system of the portable electronic device.

The following examples pertain to various embodiments.

Example 1 is a portable electronic device. The portable electronic device may include a housing partitioned into a component enclosure portion and a module bay portion, the housing including or having a border surrounding the component enclosure portion and the module bay portion. The portable electronic device may include (e.g. further include) a heat-generating component disposed within the component enclosure portion of the housing. The portable electronic device may include (e.g. further include) a heat-dissipation arrangement disposed within the component enclosure portion of the housing. The heat-dissipation arrangement may include: (i) a thermal transfer body in thermal contact with the heat-generating component, (ii) a primary thermal conveyance duct extending from the thermal transfer body with a portion of the primary thermal conveyance duct running alongside an edge of the component enclosure portion away from the module bay portion, wherein the housing includes at least one primary air vent along a first segment of the border of the housing corresponding to said edge of the component enclosure portion, and (iii) an auxiliary thermal conveyance duct extending from the thermal transfer body with a portion of the auxiliary thermal conveyance duct lining a section of the component enclosure portion bordering a first edge of the module bay portion, wherein the housing includes an auxiliary air vent along a second segment of the border of the housing corresponding to an edge of the section of the component enclosure portion opposite the first edge of the module bay portion in a manner such that the portion of the auxiliary thermal conveyance duct lies between the first edge of the module bay portion and the auxiliary air vent along the second segment of the border of the housing.

In Example 2, the subject matter of Example 1 may include that wherein the first segment of the border may include a portion of a first side wall of the housing that is opposite the module bay portion.

In Example 3, the subject matter of Example 2 may include that wherein the second segment of the border includes a portion of a second side wall of the housing that is substantially perpendicular to the first side wall, and that the auxiliary air vent is along a distal end region of the portion of the second side wall with respect to the first side wall.

In Example 4, the subject matter of any one of Examples 1 to 3 may include that the portable electronic device may further include at least one primary fan unit disposed within the component enclosure portion. Further, the housing may further include at least one primary air inlet port at the component enclosure portion. The primary fan unit may be disposed in a manner so as to be capable of drawing in air via the at least one primary air inlet port and directing the air toward the at least one primary air vent. Further, the portion of the primary thermal conveyance duct may lie between the at least one primary fan unit and the at least one primary air vent.

In Example 5, the subject matter of Example 4 may include that wherein the at least one primary air inlet port is at a segment of a base of the housing.

In Example 6, the subject matter of any one Examples 1 to 5 may include that wherein the heat-dissipation arrangement further includes a further auxiliary thermal conveyance duct extending from the thermal transfer body with a portion of the further auxiliary thermal conveyance duct lining a further section of the component enclosure portion bordering a second edge of the module bay portion that is opposite the first edge of the module bay portion, wherein the module bay portion is interposed between the section and the further section of the component enclosure portion. Further, the housing may further include a further auxiliary air vent along a third segment of the border of the housing corresponding to an edge of the further section of the component enclosure portion opposite the second edge of the module bay portion in a manner such that the portion of the further auxiliary thermal conveyance duct lies between the second edge of the module bay portion and the further auxiliary air vent along the third segment of the border of the housing.

In Example 7, the subject matter of any one of Examples 1 to 6 may include that wherein the housing further includes at least one opening fluidly connecting an interior space of the component enclosure portion and a receptacle space of the module bay portion.

In Example 8, the subject matter of Example 7 may include that wherein the housing includes a plurality of the openings. Further, a first sub-set of the plurality of the openings may be along the first edge of the module bay portion opposite the auxiliary air vent. Further, a second sub-set of the plurality of the openings may be along an edge of the module bay portion that is substantially perpendicular to the first edge of the module bay portion.

In Example 9, the subject matter of Example 8 may include that the portable electronic device may further include a fan carriage module that includes a plurality of auxiliary fan units housed within a casing of the fan carriage module, wherein the fan carriage module is removably received in the receptacle space of the module bay portion.

In Example 10, the subject matter of Example 9 may include that wherein the fan carriage module includes at least one module-carriage-primary-aperture and at least one module-carriage-secondary-aperture in the casing. With or when the fan carriage module (is) fitted in the receptacle space of the module bay portion, (i) the at least one module-carriage-primary-aperture of the fan carriage module may be aligned with at least one of the plurality of the openings of the housing and (ii) the plurality of auxiliary fan units of the fan carriage module may be capable of drawing air via the at least one module-carriage-secondary-aperture of the casing of the fan carriage module and directing the air through the at least one module-carriage-primary-aperture of the fan carriage module and the at least one of the plurality of the openings of the housing into the interior space of the component enclosure portion of the housing.

In Example 11, the subject matter of Example 9 may include that wherein the fan carriage module includes a plurality of module-carriage-primary-apertures and at least one module-carriage-secondary-aperture in the casing. With the fan carriage module fitted in the receptacle space of the module bay portion, a first sub-set of the plurality of module-carriage-primary-apertures of the fan carriage module may be respectively aligned with the first sub-set of the plurality of the openings of the housing and a second sub-set of the plurality of module-carriage-primary-apertures of the fan carriage module may be respectively aligned with the second sub-set of the plurality of the openings of the housing. Further, the plurality of auxiliary fan units of the fan carriage module may be capable of drawing air via the at least one module-carriage-secondary-aperture of the casing of the fan carriage module and directing the air through the plurality of the module-carriage-primary-apertures of the fan carriage module and the plurality of the openings of the housing into the interior space of the component enclosure portion of the housing.

In Example 12, the subject matter of any one of Examples 9 to 11 may include that the plurality of auxiliary fan units of the fan carriage module may be individually controllable.

Example 13 is a portable electronic device. The portable electronic device may include a housing partitioned into a component enclosure portion for housing an electronic component and a module bay portion configured to removably receive a module, the housing may include a border surrounding the component enclosure portion and the module bay portion. The housing may include at least one air vent along a segment of the border of the housing corresponding to an edge of the component enclosure portion opposite an edge of the module bay portion. The housing may include a partitioning formation serving as a boundary between the component enclosure portion and the module bay portion. The housing may include a plurality of openings at the partitioning formation for air transfer between the component enclosure portion and the module bay portion, wherein at least one of the plurality of the openings may be aligned with the at least one air vent. The portable electronic device may include (e.g. further include) a power connection arrangement at the partitioning formation, wherein the power connection arrangement may be connectable to the module for power transfer between the electronic component in the component enclosure portion and the module when the module is removably received in the module bay portion.

In Example 14, the subject matter of Example 13 may include that the module may include a power source module or a fan carriage module. Further, the power source module and the fan carriage module may interchangeable with one another such that either may be removably received in the module bay portion at any one time. Yet further, the power connection arrangement may be configured to be connectable to the power source module when the power source module is removably received in the module bay portion and connectable to the fan carriage module when the fan carriage module is removably received in the module bay portion.

In Example 15, the subject matter of Example 14 may include that the portable electronic device may include (e.g. further include) the power source module removably received in the module bay portion, wherein, with the power source module fitted in the module bay portion, the power source module may be configured to supply power to the electronic component in the component enclosure portion via the power connection arrangement.

In Example 16, the subject matter of Example 14 may include that the portable electronic device may include (e.g. further include) the fan carriage module removably received in the module bay portion. The fan carriage module may include a plurality of fan units housed within a casing of the fan carriage module. The fan carriage module may include at least one module-carriage-primary-aperture and at least one module-carriage-secondary-aperture in the casing. With the fan carriage module fitted in the module bay portion, (i) the at least one module-carriage-primary-aperture of the fan carriage module may be aligned with one or more of the plurality of the openings of the housing and (ii) the plurality of fan units of the fan carriage module may be capable of drawing air via the at least one module-carriage-secondary-aperture of the casing of the fan carriage module and directing the air through the at least one module-carriage-primary-aperture of the fan carriage module and the one or more of the plurality of the openings of the housing into the component enclosure portion of the housing. Further, with the fan carriage module fitted in the module bay portion, the fan carriage module may be configured to draw power from the electronic component in the component enclosure portion via the power connection arrangement.

In Example 17, the subject matter of Example 16 may include that wherein, with the fan carriage module fitted in the module bay portion, the plurality of fan units of the fan carriage module may be individually controllable.

In Example 18, the subject matter of any one of Examples 13 to 17 may include that wherein the first sub-set of the plurality of the openings are at a first segment of the partitioning formation and a second sub-set of the plurality of the openings are at a second segment of the partitioning formation that is adjacent to the first segment. The first segment and the second segment of the partitioning formation may be non-parallel to each other.

In Example 19, the subject matter of Example 18 may include that the first segment and the second segment of the partitioning formation are substantially perpendicular to each other.

In Example 20, the subject matter of Example 18 or Example 19 may include that a third sub-set of the plurality of the openings may be at a third segment of the partitioning formation adjacent to the second segment of the partitioning formation such that the second segment lies between the first segment and the third segment of the partitioning formation. The first segment and the third segment of the partitioning formation may be substantially parallel with each other.

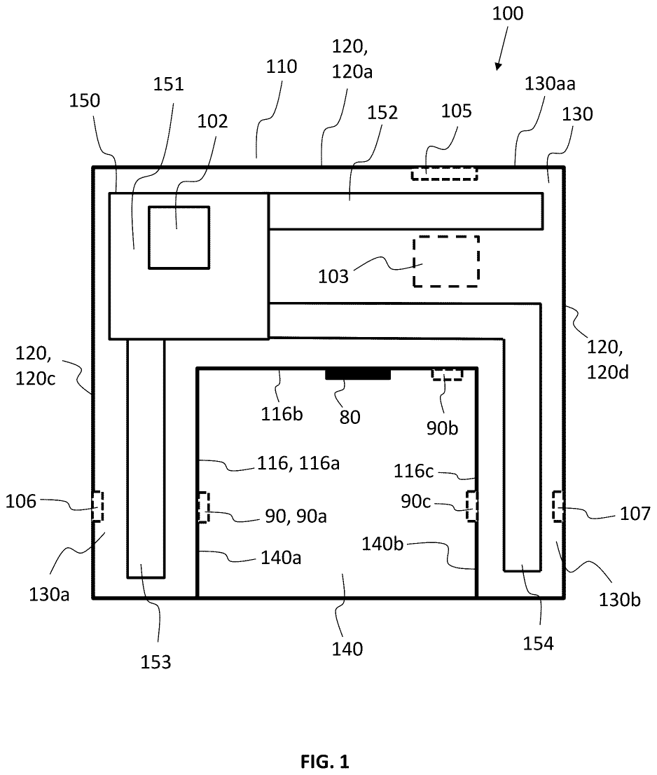

FIG. 1 shows a schematic diagram of a portable electronic device 100, according to various embodiments.

According to various embodiments, there may be provided the portable electronic device 100. The portable electronic device 100 may include or may be any one of a notebook, a portable personal computer (PC), a laptop, a tablet, a palmtop, etc. For ease of illustration, various embodiments may be described with reference to the portable electronic device 100 being or including a laptop. Nevertheless, it is understood that various embodiments described as such is not limited thereto. Thus, the portable electronic device 100 according to various embodiments may include or may be any other (e.g. type of) portable electronic device 100.

As shown in FIG. 1, the portable electronic device 100 may include a housing 110 (e.g. an outer casing). According to various embodiments, the housing 110 may include a base portion and a roof portion (not shown) opposite the base portion. The roof portion may include an opening which may, for example, be for allowing keys of a keyboard assembly (e.g. disposed within the housing 110) to be exposed. The housing 110 may include a border 120. The border 120 may be an outer boundary or a periphery outline of the housing 110. Accordingly, the border 120 may be surrounding each of the base portion and the roof portion. Thus, for example, the border 120 may include or may be side wall(s) (e.g. a pair of opposite longitudinal side walls and a pair of opposite lateral side walls extending between the pair of opposite longitudinal side walls) or side edge(s) or flank(s) of the housing 110, which may be extending between edge(s) of the base portion and edge(s) of the roof portion.

According to various embodiments, the housing 110 may be partitioned into a component enclosure portion 130 and a module bay portion 140. Accordingly, the housing 110 may include the component enclosure portion 130 and the module bay portion 140 that together forms the housing 110 as a single structural whole. Further, the component enclosure portion 130 and the module bay portion 140 may be adjoining or immediately adjacent each other so as to be side-by-side within the border 120 of the housing 110. For example, the housing 110 may include a partitioning formation 116 (e. g. a partitioning wall/inner longitudinal wall/interior wall/interior barrier) extending between the base portion and the roof portion of the housing 110. Hence, the partitioning formation 116 may partition or divide or separate the housing 110 into the component enclosure portion 130 and the module bay portion 140. In other words, the partitioning formation 116 may serve as a boundary between the component enclosure portion 130 and the module bay portion 140. According to various embodiments, the partitioning formation 116 may include or may have, for example, a box shape, a squarish shape, or a rectangular shape, etc., (as depicted in FIG. 1), or any other shape (e. g. a hemisphere shape, a trapezoid shape, a triangular shape, etc.). As an example, with reference to FIG. 1, the partitioning formation 116 may include at least a first segment 116a and a second segment 116b adjacent to the first segment 116a. According to various embodiments, the partitioning formation may include (e. g. further include) a third segment 116c adjacent to the second segment 116b such that the second segment 116b may lie between the first segment 116a and the third segment 116c. According to various embodiments, when the partitioning formation 116 includes at least the first segment 116a and the second segment 116b, the first segment 116a and the second segment 116b may be non-parallel to each other (e. g. forming an acute angle or 90° facing, or on the side of, the module bay portion 140). For example, as shown in FIG. 1, the first segment 116a and the second segment 116b may be perpendicular (e. g. substantially perpendicular) to each other (in other words, forming a right angle which is facing, or on the side of, the module bay portion 140). According to various embodiments, as shown in FIG. 1, when the partitioning formation 116 also includes the third segment 116a, the first segment 116a and the third segment 116c may be parallel (e. g. substantially parallel) with each other. According to various other embodiments (not shown), the first segment 116a and the third segment 116c may be non-parallel to each other. As shown in FIG. 1, according to various embodiments, the component enclosure portion 130 may be on one side of the partitioning formation 116 while the module bay portion 140 may be on an opposite side of the partitioning formation 116. Further, both the component enclosure portion 130 and the module bay portion 140 may be surrounded by the border 120. According to various embodiments, the component enclosure portion 130 of the housing 110 may define an interior space for housing 110 various components (e. g. electronic components, electrical components, mechanical components, etc.) of the portable electronic device 100. In other words, the component enclosure portion 130 may be for housing one or more electronic component(s) and/or hardware. According to various embodiments, the module bay portion 140 of the housing 110 may define a receptacle space for receiving a removable module that may be fitted into the receptacle space and removed from the receptacle space. In other words, the module bay portion 140 may be configured to removably receive a module (described in detail later). According to various embodiments, an entire inner volume bound by the border 120 of the housing 110 may be divided or partitioned or separated into the interior space of the component enclosure portion 130 and the receptacle space of the module bay portion 140.

According to various embodiments, the portable electronic device 100 may include (e.g. further include) a heat-generating component 102 disposed within the component enclosure portion 130 of the housing 110. Accordingly, the heat-generating component 102 may be in the interior space of the component enclosure portion 130 of the housing 110. The heat-generating component 102 may be an electronic/electrical component that processes information or performs operation, and generates heat as a result. For example, the heat-generating component 102 may be, but is not limited to, any one or more of a Motherboard, a Central Processing Unit and/or a Graphics Processing Unit (e.g. on a Printed Circuit Board), etc., or any electronic component (e.g. an internal battery) of the portable electronic device 100.

The portable electronic device 100 may include (e. g. further include) a heat-dissipation arrangement 150 configured to or for dissipating heat away from the heat-generating component 102. The heat-dissipation arrangement 150 may be disposed within the component enclosure portion 130 of the housing 110. Accordingly, the heat-dissipation arrangement 150 may be disposed in the interior space of the component enclosure portion 130 of the housing 110 and may be associated with the heat-generating component 102. In particular, the heat-dissipation arrangement 150 may include a thermal transfer body 151 which may be in thermal contact (e. g. in direct contact or indirect contact, for example, via an intervening layer of thermal interface material) with the heat-generating component 102. For example, the thermal transfer body 151 may include, but not limited to, a vapor chamber, a thermal plate, a cold plate, etc. Further, the heat-dissipation arrangement 150 may include a primary thermal conveyance duct 152 and an auxiliary thermal conveyance duct 153 for thermally conveying heat away from the heat-generating component 102 (or from the thermal transfer body 151 in thermal contact with the heat-generating component 102). Accordingly, the heat-dissipation arrangement 150 may remove or dissipate the heat generated by the heat-generating component 102. According to various embodiments, each of the primary thermal conveyance duct 152 and the auxiliary thermal conveyance duct 153 may include or may be a thermally conductive elongate member (e. g. arm member), a heat pipe, or a heat exchanger, etc. According to various embodiments, each of the primary thermal conveyance duct 152 and the auxiliary thermal conveyance duct 153 may, or may not, include one or more cooling fins (e. g. at/projecting from an intermediate portion and/or end portion(s) thereof). According to various embodiments, the primary thermal conveyance duct 152 may be extending from the thermal transfer body 151 with a portion (e. g. an intermediate portion, or one or both end portion(s)) of the primary thermal conveyance duct 152 running alongside an edge 130aa of the component enclosure portion 130 away from (in other words or for example, separate from, or apart from, or across from, or not coinciding with, etc.) the module bay portion 140. According to various embodiments, said edge 130aa of the component enclosure portion 130 may correspond with a first segment 120a of the border 120 of the housing 110. Hence, the portion of the primary thermal conveyance duct 152 may extend alongside the first segment 120a of the border 120 of the housing 110. The auxiliary thermal conveyance duct 153 may be extending from the thermal transfer body 151 with a portion (e. g. an intermediate portion and/or an end portion) of the auxiliary thermal conveyance duct 153 lining (e. g. tracing, or extending along) a section 130a (e. g. a first zone) of the component enclosure portion 130. The section 130a (e. g. the first zone) of the component enclosure portion 130 may be bordering (e. g. may be adjacent or beside) a first edge 140a (e. g. a first lateral edge, or first longitudinal edge, etc.) of the module bay portion 140. Accordingly, the section 130a of the component enclosure portion 130 may skirt the first edge 140a of the module bay portion 140 so as to lie next to or flank the first edge 140a of the module bay portion 140. Further, the portion of the auxiliary thermal conveyance duct 153 may align to (or align with) and occupy the section 130a of the component enclosure portion 130.

The housing 110 of the portable electronic device 100 may include (e.g. further include) at least one primary air vent 105 along the first segment 120a of the border 120 of the housing 110 which may be corresponding to the edge 130aa of the component enclosure portion 130 along which the portion of the primary thermal conveyance duct 152 may be extending. Accordingly, the at least one primary air vent 105 may be adjacent to the portion of the primary thermal conveyance duct 152 running alongside the edge 130aa of the component enclosure portion 130. Accordingly, the heat from the heat-generating component 102 may be conveyed from the thermal transfer body 151 to the thermal conveyance duct (e.g. via conduction/convection) and may then be dissipated out through the at least one primary air vent 105 (e.g. via convection/radiation). As an example, the first segment 120a of the border 120 of the housing 110 may include or may be, but is not limited to, a first side wall of the housing 110.

The housing 110 may include (e.g. further include) an auxiliary air vent 106 (e.g. at least one air vent or at least one other air vent) along a second segment 120c (e.g. a segment or another segment) of the border 120 of the housing 110. As shown, the second segment 120c of the border 120 of the housing 110 may be corresponding to an edge of the section 130a (e.g. the first zone) of the component enclosure portion 130 (e.g. an edge of the component enclosure portion 130). According to various embodiments, said edge of the section 130a of the component enclosure portion 130 may be opposite the first edge 140a of the module bay portion 140. Accordingly, said edge of the section 130a of the component enclosure portion 130 may be directly across from the first edge 140a of the module bay portion 140. Hence, the auxiliary air vent 106 may be opposite (e.g. directly opposite) the first edge 140a of the module bay portion 140. In other words, the auxiliary air vent 106 and the first edge 140a of the module bay portion 140 may be on two opposite edges of the section 130a of the component enclosure portion 130 and across the section 130a of the component enclosure portion 130. Thus, the portion (e.g. intermediate portion, and/or end portion) of the auxiliary thermal conveyance duct 153, which is lining the section 130a of the component enclosure portion 130, may lie or may be interposed between the first edge 140a of the module bay portion 140 and the auxiliary air vent 106. In such a configuration, the auxiliary air vent 106 may be adjacent to the portion of the auxiliary thermal conveyance duct 153. As such, the heat from the heat-generating component 102 may be conveyed from the thermal transfer body 151 to the auxiliary thermal conveyance duct 153 and may then be dissipated out of the auxiliary air vent 106. As an example, the second segment 120c of the border 120 of the housing 110, which may be corresponding to said edge of the section 130a (e.g. the first zone) of the component enclosure portion 130 that is opposite the first edge 140a of the module bay portion 140, may include or may be, but is not limited to, a second side wall of the housing 110 which is perpendicular (e.g. substantially perpendicular) to the first segment 120a of the border 120 (e.g. the first side wall).

According to various embodiments, the heat-dissipation arrangement 150 may include (e. g. further include) a further auxiliary thermal conveyance duct 154 (i. e. in addition to the above-said auxiliary thermal conveyance duct 153). The further auxiliary thermal conveyance duct 154 may include or may be a thermally conductive elongate member (e. g. arm member), a heat pipe, or a heat exchanger, etc. Further, the further auxiliary thermal conveyance duct 154 may, or may not, include one or more cooling fins (e. g. at an intermediate portion and/or end portion(s) thereof). The further auxiliary thermal conveyance duct 154 may be extending from the thermal transfer body 151 with a portion (e. g. an intermediate portion and/or an end portion) of the further auxiliary thermal conveyance duct 154 lining a further section 130b (e. g. a second zone) of the component enclosure portion 130 bordering a second edge 140b (e. g. a second lateral edge, or second longitudinal edge, etc.) of the module bay portion 140. Accordingly, the further section 130b (e. g. second zone) of the component enclosure portion 130 may skirt the second edge 140b of the module bay portion 140 so as to lie next to or flank the second edge 140b of the module bay portion 140. Further, said portion of the further auxiliary thermal conveyance duct 154 may align to and occupy the further section 130b of the component enclosure portion 130. According to various embodiments, the second edge 140b of the module bay portion 140 may be opposite the first edge 140a of the module bay portion 140. Accordingly, the further section 130b (e. g. the second zone) of the component enclosure portion 130 may be opposite the section 130a (e. g. the first zone) of the component enclosure portion 130. The module bay portion 140 may thus be interposed between the section 130a (e. g. the first zone) and further section 130b (e. g. the second zone) of the component enclosure portion 130.

The housing 110 may include (e.g. further include) a further auxiliary air vent 107 (i.e. in addition to the above-said auxiliary air vent 106) along a third segment 120d of the border 120 of the housing 110. The third segment 120d of the border 120 of the housing 110 may be corresponding to an edge of the further section 130b (e.g. the second zone) of the component enclosure portion 130. Said edge of the further section 130b of the component enclosure portion 130 may be opposite the second edge 140b of the module bay portion 140. Accordingly, said edge of the further section 130b of the component enclosure portion 130 may be directly across from the second edge 140b of the module bay portion 140. Hence, the further auxiliary air vent 107 and the second edge 140b of the module bay portion 140 may be on two opposite edges of the further section 130b of the component enclosure portion 130 and across the further section 130b of the component enclosure portion 130. Thus, the portion of the further auxiliary thermal conveyance duct 154, which is lining the further section 130b of the component enclosure portion 130, may lie or may be interposed between the second edge 140b of the module bay portion 140 and the further auxiliary air vent 107. In such a configuration, the further auxiliary air vent 107 may be adjacent to said portion of the further auxiliary thermal conveyance duct 154. In this configuration, the heat from the heat-generating component 102 may be conveyed from the thermal transfer body 151 to the further auxiliary thermal conveyance duct 154 and may then be dissipated out of the further auxiliary air vent 107. As an example, the third segment 120d of the border 120 of the housing 110, which may be corresponding to the edge of the further section 130b (e.g. the second zone) of the component enclosure portion 130 opposite the second edge 140b of the module bay portion 140, may include or may be, but is not limited to, a third side wall of the housing 110 which may be opposite the second segment 120c of the border 120 (e.g. the second side wall).

As shown in FIG. 1, an end portion of the auxiliary thermal conveyance duct 153 (and/or an end portion of the further auxiliary thermal conveyance duct 154) may be at an opposite side (or section, zone, etc.) of the component enclosure portion 130 from where the primary thermal conveyance duct 152 (e.g. the entire primary thermal conveyance duct 152) may be disposed. According to various embodiments, the auxiliary thermal conveyance duct 153 (and/or the further auxiliary thermal conveyance duct 154) may be extending (i.e. from the thermal transfer body 151) in a direction away from, or non-parallel (e.g. substantially perpendicularly) with respect to, the primary thermal conveyance duct 152.

According to various embodiments, the housing 110 may include (e. g. further include) at least one primary air inlet port 103 (depicted in dashed lines in FIG. 1) at the component enclosure portion 130. The at least one primary air inlet port 103 may be at a part of the housing 110 which bounds the component enclosure portion 130. For example, the at least one primary air inlet port 103 may be on the base portion of the housing 110. According to various other embodiments (not shown), the at least one primary air inlet port may be along or on a side wall of the housing 110 (e. g. in addition or alternative to being on the base portion of the housing 110). The at least one primary air inlet port 103 may be configured or disposed in a manner so as to allow air (e. g. air surrounding the portable electronic device 100) to enter the component enclosure portion 130 for cooling (e. g. cooling at least) the thermal transfer body 151 and/or the heat-generating component 102 and/or the primary thermal conveyance duct 152 and/or the auxiliary thermal conveyance duct 153.

The portable electronic device 100 may include (e. g. further include) at least one primary fan unit (e. g. at least one fan unit) (not shown in FIG. 1) disposed within the component enclosure portion 130 of the housing 110. The at least one primary fan unit may be disposed in a manner so as to be capable of drawing air (e. g. into the component enclosure portion 130) via the at least one primary air inlet port 103 and (e. g. thereafter) directing the air toward (e. g. out of at least) the at least one primary air vent 105. Accordingly, the at least one primary fan unit may be between the at least one primary air inlet port 103 and the at least one primary air vent 105. In particular, the pressure side of the at least one primary fan unit may be facing (or aligned, in register with, etc.) the at least one primary air vent 105, while the suction side of the at least one primary fan unit may be facing (or aligned, in register with, etc.) the primary air inlet port 103.

The portion (e.g. intermediate portion, or end portion) of the primary thermal conveyance duct 152 may lie or may be disposed between (e.g. directly between) the at least one primary fan unit (e.g. pressure side of the at least one primary fan unit) and the at least one primary air vent 105. Accordingly, the at least one primary fan unit may cause air (e.g. cooler air) to pass over the portion of the primary thermal conveyance duct 152 (e.g. to facilitate heat dissipation by the primary thermal conveyance duct 152) before exiting (e.g. exiting at least) the at least one primary air vent 105 (e.g. as warmer air).

According to various embodiments, the module bay portion 140 may include or may be a hollow socket defining the receptacle space. For example, the partitioning formation 116 of the housing 110 may form the hollow socket or may define or serve as a boundary of the receptacle space of the module bay portion 140.

The module bay portion 140 (or the hollow socket of the module bay portion 140) may be configured to removably receive a module. In particular, the module bay portion 140 may be configured (e.g. shaped) to interchangeably receive either a power source module (e.g. portable battery) or a fan carriage module. The portable electronic device 100 may include (e.g. further include) a power connection arrangement 80 (e.g. electrical/power distribution arrangement, one or more power terminal(s), electrical connector(s), electrical/power line(s), busbar, etc.) at the partitioning formation 116. The power connection arrangement 80 may be connectable to the module (e.g. power source module or fan carriage module) for power transfer between an electronic component in the component enclosure portion 130 and the module when the module is removably received (or fitted) in the module bay portion 140. As such, the portable electronic device 100, according to the various embodiments, may provide a user of the portable electronic device 100 with an option to power the portable electronic device 100 using a portable power source (i.e. the power source module) or to have additional cooling from a plurality of auxiliary fan units of the fan carriage module (described in detail below) (e.g. when a portable power source is not required, and/or the user requires the portable electronic device 100 to run at a higher capacity, etc.).

Accordingly, the portable electronic device 100 may be removably (or detachably) fitted with either the power source module or the fan carriage module in the module bay portion 140 (e.g. within the receptacle space of the module bay portion 140 or the hollow socket of the module bay portion 140). Hence, the power source module and the fan carriage module may be interchangeable or swappable with each other, and, at any one time, the portable electronic device 100 may include either the power source module or the fan carriage module received or fitted in the module bay portion 140. According to various embodiments, when the power source module is fitted in the module bay portion 140, the power source module may be configured to supply power to an electronic component (e.g. a processor) in the component enclosure portion 130 via the power connection arrangement 80. According to various embodiments, when the fan carriage module is fitted in the module bay portion 140, the fan carriage module may be configured to draw power from an electronic component (e.g. internal battery) in the component enclosure portion 130 via the power connection arrangement 80. Accordingly, each of the power source module or the fan carriage module may be configured to be connectable to the power connection arrangement 80. For example, the power source module may include a connector connectable to the power connection arrangement 80. Similarly, the fan carriage module may include a connector connectable to the power connection arrangement 80. Further, the connector of the power source module and the connector of the fan carriage module may be the same or may be different.

According to various embodiments, the housing 110 may include (e. g. further include) at least one opening 90. For example, the at least one opening 90 may be at the partitioning formation 116 of the housing 110 separating the interior space of the component enclosure portion 130 and the receptacle space of the module bay portion 140. Specifically, the at least one opening 90 may be extending through the partitioning formation 116 from a first face of the partitioning formation 116 facing the module bay portion 140 to an opposite second face of the partitioning formation 116 facing the component enclosure portion so as to form at least one through-hole across the partitioning formation 116. Accordingly, the at least one opening 90 may be configured to or may be for fluidly connecting the interior space of the component enclosure portion 130 and the receptacle space of the module bay portion 140. The at least one opening 90 may be for air to pass through or, in other words, configured to enable air transfer between the module bay portion 140 and the component enclosure portion 130. For ease of illustration, various embodiments may be described with reference to the at least one opening 90 configured to allow air to pass through. Nevertheless, it is understood that various embodiments described as such is not limited thereto. For example, in some embodiments, the at least one opening 90 may, in addition to allowing air to pass through, may provide access for physical electrical connection between the power source module and an electrical component (e. g. one or more electrical components) of the portable electronic device 100.

According to various embodiments, the fan carriage module may include a casing (e. g. outer shell, frame, outer frame, enclosure, etc.). Further, the fan carriage module may include a plurality of auxiliary fan units (e. g. fan units) (see, for example, reference 271 in FIG. 2A) supported or held or carried or housed within the casing. In other words, the casing may be configured to support or hold or carry or house the plurality of auxiliary fan units therewithin. The casing may include at least one module-carriage-primary-aperture (e. g. through-hole, vent, opening, etc.) and at least one module-carriage-secondary-aperture (e. g. through-hole, vent, opening, etc.). The at least one module-carriage-primary-aperture may be arranged in a manner such that, when or with the fan carriage module is within (i. e. received or seated or fitted within) the receptacle space of the module bay portion 140, the at least one module-carriage-primary-aperture may be aligned with one (or more) of the at least one opening 90 of the housing 110 fluidly connecting the interior space of the component enclosure portion 130 and the receptacle space of the module bay portion 140. Further, the plurality of auxiliary fan units may be arranged within the casing in a manner so as to be capable of drawing air (e. g. into the casing) via the at least one module-carriage-secondary-aperture of the casing of the fan carriage module and directing the air through the at least one module-carriage-primary-aperture of the fan carriage module and the at least one opening 90 of the housing 110 such that the air may flow into the interior space of the component enclosure portion 130 of the housing 110.

According to various embodiments, the housing 110 may include a plurality of openings 90 at the partitioning formation 116. Specifically, the plurality of the openings 90 may be extending through the partitioning formation 116 from a first face of the partitioning formation 116 facing the module bay portion 140 to an opposite second face of the partitioning formation 116 facing the component enclosure portion so as to form a plurality of through-holes across the partitioning formation 116. Accordingly, the plurality of the openings 90 may be configured to or may be for fluidly connecting the receptacle space of the module bay portion 140 and the interior space of the component enclosure portion 130 (in other words, configured to enable or for air transfer between the module bay portion 140 and the component enclosure portion 130). According to various embodiments, a first sub-set 90a of the plurality of the openings 90 may be at the first segment 116a of the partitioning formation 116. Another sub-set of the plurality of the openings 90 (e. g. a second sub-set 90b of the plurality of the openings 90) may be at the second segment 116b of the partitioning formation 116. Yet another sub-set of the plurality of the openings 90 (e. g. a third sub-set 90c of the plurality of the openings 90) may be at the third segment 116c of the partitioning formation 116. According to various embodiments, at least one of the plurality of the openings 90 or a sub-set of the plurality of the openings 90 (e. g. the first sub-set 90a of the plurality of the openings 90) and the auxiliary air vent 106 may be aligned with each other (e. g. directly aligned, or a hole axis of each of the first sub-set 90a of the plurality of the openings 90 may be parallel or substantially parallel with a hole axis of the auxiliary air vent 106). According to various embodiments, at least another of the plurality of the openings or another sub-set of the plurality of the openings 90 (e. g. the second sub-set 90b of the plurality of the openings 90) may be aligned with the primary air vent 105. According to various embodiments, at least yet another of the plurality of the openings 90 or yet another sub-set of the plurality of the openings 90 (e. g. the third sub-set 90c of the plurality of the openings 90) and the further auxiliary air vent 207 may be aligned with each other.

According to various embodiments, the fan carriage module may include a plurality of module-carriage-primary-apertures. Accordingly, according to various embodiments, with the fan carriage module fitted in the receptacle space of the module bay portion 140, a first sub-set of the plurality of module-carriage-primary-apertures may be respectively aligned with at least one (e. g. one or more) of the plurality of the openings 90 or a sub-set of the plurality of the openings 90 (e. g. the first sub-set 90a of the plurality of the openings 90) and (e. g. further) a second sub-set of the plurality of module-carriage-primary-apertures may be respectively aligned with at least another (e. g. one or more other) of the plurality of the openings 90 or another sub-set of the plurality of the openings 90 (e. g. the second sub-set 90b of the plurality of the openings 90). According to various embodiments, a first sub-set of the plurality of auxiliary fan units may be arranged in a manner so as to be capable of directing air into or towards the interior space of the component enclosure portion 130 via the first sub-set of module-carriage-primary-apertures and the at least one of the plurality of the openings 90, or the sub-set of the plurality of the openings 90 (e. g. the first sub-set 90a of the plurality of the openings 90), that are aligned. According to various embodiments, a second sub-set of the plurality of auxiliary fan units may be arranged in a manner so as to be capable of directing air into or towards the interior space of the component enclosure portion 130 via the second sub-set of module-carriage-secondary-apertures and at least another of the plurality of the openings 90, or the other sub-set of the plurality of the openings 90 (e. g. the second sub-set 90b of the plurality of the openings 90), that are aligned. According to various embodiments, a third sub-set of the plurality of auxiliary fan units may be arranged in a manner so as to be capable of directing air into or towards the interior space of the component enclosure portion 130 via the third sub-set of module-carriage-secondary-apertures and at least yet another of the plurality of the openings 90, or yet another sub-set of the plurality of the openings 90 (e. g. the third sub-set 90c of the plurality of the openings 90), which may be aligned.

According to various embodiments, the plurality of auxiliary fan units of the fan carriage module may be individually controllable, for example, via a controller, a processor, or any hardware (e.g. a keyboard, mouse) and/or electronic component (e.g. housed in the component enclosure portion 130), and/or via software, application, etc., or by any other suitable means. Specifically, with the fan carriage module fitted in the module bay portion 140, any one or more or all of the plurality of auxiliary fan units may be individually or simultaneously controlled to be in an “operational” mode to circulate air, while remaining or other auxiliary fan unit(s) of the plurality of auxiliary fan units may be in a “non-operational” mode (in other words, not functioning/not circulating any air).

FIG. 2A shows a schematic bottom view of a portable electronic device 200 which includes a heat-dissipation arrangement 250, and a fan carriage module 270 within a module bay portion 240 of a housing 210 of the portable electronic device 200, according to various embodiments.

According to various embodiments, there may be provided the portable electronic device 200 (e.g. a laptop).

According to various embodiments, the portable electronic device 200 may contain any one or more or all the features and/or limitations of the portable electronic device 100 of FIG. 1. In the following, the portable electronic device 200 is described with like reference characters generally referring to the same or corresponding parts/features of the portable electronic device 100 of FIG. 1. The description of the parts/features made with respect to the portable electronic device 200 may be applicable with respect to the portable electronic device 100, and vice versa

According to various embodiments, the portable electronic device 200 may, similar to the portable electronic device 100 of FIG. 1, include a housing 210. As shown, the housing 210 may include a border 220 which may include or may be a pair of opposite longitudinal side walls (e.g. first longitudinal side wall 220a and second longitudinal side wall 220b) and a pair of opposite lateral side walls (e.g. first lateral side wall 220c and second lateral side wall 220d) extending between the pair of opposite longitudinal side walls 220a, 220b.

Further, the housing 210 may be partitioned into a component enclosure portion 230 and a module bay portion 240. The component enclosure portion 230 may include a main section 230c (e.g. square/rectangular/boxed-shaped section) as well as a first section 230a (e.g. first elongate section) and a second or further section 230b (e.g. second elongate section) opposite the first section 230a. As shown, each of the first section 230a and the second section 230b may be extending from one side of the main section 230c. The first section 230a may be bordering a first edge 240a of the module bay portion 240 which may correspond to a first inner side wall 213 (see FIG. 2B) of the housing 210. The second section 230b may be bordering a second edge 240b of the module bay portion 240 which may correspond to a second inner side wall 214 (see FIG. 2B) of the housing 210 opposite the first inner side wall 213. Accordingly, the module bay portion 240 may lie or may be interposed between the first section 230a and the second section 230b of the component enclosure portion 230. As shown, the module bay portion 240 may include or may be, but is not limited to, a square/rectangular/boxed-shaped section.

The portable electronic device 200 may, similar to the portable electronic device 100 of FIG. 1, include a heat-generating component (e.g. behind the heat-dissipation arrangement 250 in FIG. 2A) disposed within the component enclosure portion 230. Specifically, the heat-generating component may be disposed within (e.g. within at least) the main section 230c of the component enclosure portion 230.

The portable electronic device 200 may, similar to the portable electronic device 100 of FIG. 1, include the heat-dissipation arrangement 250 disposed within the component enclosure portion 230.

As shown, the heat-dissipation arrangement 250 may include a thermal transfer body 251 (e.g. a thermally conductive plate) which may be in thermal contact with the heat-generating component. For instance, the thermal transfer body 251 and the heat-generating component may be stacked one over another.

Further, as shown, the heat-dissipation arrangement 250 may include a primary thermal conveyance duct 252 as well as an auxiliary thermal conveyance duct 253 and a further an auxiliary thermal conveyance duct 253.

As shown, the primary thermal conveyance duct 252 may be extending from the thermal transfer body 251, with a portion (e.g. at least a portion, for instance, both end portions or the entire) of the primary thermal conveyance duct 252 running alongside an edge (e.g. a first longitudinal edge/rear edge) of the component enclosure portion 230 that is away (or apart) from the module bay portion 240. As shown, the edge may be opposite the module bay portion 240. According to various embodiments, the primary thermal conveyance duct 252 may be, but is not limited to, being integral or integrally formed with the thermal transfer body 251. For example, as shown, an intermediate portion of the primary thermal conveyance duct 252 may be integrally formed with the thermal transfer body 251 (e.g. at an edge of the thermal transfer body 251, such that the primary thermal conveyance duct 252 and the thermal transfer body 251 form a “T”-shaped or substantially “T”-shaped structure/arrangement).

The auxiliary thermal conveyance duct 253 may be extending from the thermal transfer body 251 (e.g. at an opposite side of the thermal transfer body 251 from the primary thermal conveyance duct 252), with a portion (e.g. an end portion) of the auxiliary thermal conveyance duct 253 lining (e.g. extending into/along) the first section 230a of the component enclosure portion 230.

The further auxiliary thermal conveyance duct 254 may be extending from the thermal transfer body 251 (e.g. at an opposite side of the thermal transfer body 251 from the primary thermal conveyance duct 252), with a portion (e.g. an end portion) of the auxiliary thermal conveyance duct 253 lining (e.g. extending into/along) the second section 230b of the component enclosure portion 230.

Accordingly, as shown, both the auxiliary thermal conveyance duct 253 and the further auxiliary thermal conveyance duct 254 may be extending in a direction away from the primary thermal conveyance duct 252 (or away from the first longitudinal edge of the component enclosure portion 230). Further, as shown, the end portion of the auxiliary thermal conveyance duct 253 and the end portion of the further auxiliary thermal conveyance duct 254 may be, but is not limited to being, parallel with each other (and/or parallel with the first lateral side wall 220c and the second lateral side wall 220d of the housing 210). Each of the auxiliary thermal conveyance duct 253 and the further auxiliary thermal conveyance duct 254 may include or may be, but is not limited to, a heat pipe in thermal contact with (in other words, thermally connected to) the thermal transfer body 251 (e.g. at respective opposite end portions of the auxiliary thermal conveyance duct 253 and the further auxiliary thermal conveyance duct 254).

As shown, the housing 210 may include at least one primary air vent 205 adjacent to the primary thermal conveyance duct 252. Specifically, the at least one primary air vent 205 may include a pair of primary air vents 205 respectively positioned at opposite end regions of the first longitudinal side wall 220a (i.e. first segment of the border 220) of the housing 210 which may correspond to the edge (e.g. the first longitudinal edge/rear edge) of the component enclosure portion 230 (i.e. along which the portion of the primary thermal conveyance duct 252 may be running).

Further, the housing 210 may include an auxiliary air vent 206 adjacent to the auxiliary thermal conveyance duct 253 as well as include a further auxiliary air vent 207 adjacent to the further auxiliary thermal conveyance duct 254. Specifically, the auxiliary air vent 206 may be positioned at an end region of the first lateral side wall 220c (i.e. second segment of the border 220) that is distal from the first longitudinal side wall 220a. The further auxiliary air vent 207 may be positioned at an end region of the second lateral side wall 220d (i.e. third segment of the border 220) that is distal from the first longitudinal side wall 220a. In other words, according to various embodiments, the auxiliary air vent 206 may be positioned at a bottom/front-right corner region of the housing 210 (when viewed from a top view) and the further auxiliary air vent 207 may be positioned at a bottom/front-left corner region of the housing 210 (when viewed from a top view).

Additionally, the housing 210 of the portable electronic device 200 may, similar to the housing 110 of the portable electronic device 100 of FIG. 1, include at least one primary air inlet port (not shown in FIG. 2A). Specifically, the housing 210 may include two (or at least two sets of) air inlet ports at a base portion (e.g. base surface) of the housing 210.

Further, the portable electronic device 200 may, similar to the portable electronic device 100 of FIG. 1, include at least one primary fan unit 260. Specifically, as shown, the portable electronic device 200 may include two (e.g. at least two) primary fan units 260. With reference to FIG. 2A, the two primary fan units 260 may be respectively positioned on opposite sides of the thermal transfer body 251, such that each primary fan unit 260 may be between the thermal transfer body 251 and a respective lateral side wall 220c, 220d of the housing 210. A suction side of each primary fan unit 260 may be facing or directed towards (e.g. aligned with) or in register (e.g. in fluid connection) with a respective primary air inlet port (not shown in FIG. 2A), while a pressure side of the primary fan unit 260 may be facing or directed towards or in register with a respective primary air vent 205. As shown, a respective portion (e.g. end portion) of the primary thermal conveyance duct 252 may be lying or interposed between the pressure side of a respective primary fan unit 260 and a respective primary air vent 205. Accordingly, each primary fan unit 260 may be capable of circulating air across the portion of the primary thermal conveyance duct 252 (e.g. in a direction or along a flow path from the respective primary air inlet port to the respective primary air vent 205), to cool the primary thermal conveyance duct 252. According to various embodiments, the pressure side and the suction side of each primary fan unit 260 may be, but is not limited to being, perpendicular (e.g. substantially perpendicular) sides to each other.

FIG. 2B shows a schematic bottom view of the portable electronic device 200 of FIG. 2A with a power source module 280 within the module bay portion 240 of the housing 210 of the portable electronic device 200, according to various embodiments.

Similar to the portable electronic device 100 of FIG. 1, the module bay portion 240 of the housing 210 of the portable electronic device 200 may be configured (e.g. as a hollow socket defining a receptacle space) to interchangeably receive either the fan carriage module 270 (see FIG. 2A) or the power source module 280 (e.g. portable battery, as shown in FIG. 2B).

Accordingly, the housing 210 of the portable electronic device 200 may, similar to the housing 110 of the portable electronic device 100 of FIG. 1, include a plurality of openings fluidly connecting an interior space of the component enclosure portion 230 and the module bay portion 240. In particular, a first sub-set of the plurality of the openings of the housing 210 may be along the first inner side wall 213 of the housing 210, a second sub-set of the plurality of the openings of the housing 210 may be along a second inner side wall 214 of the housing 210 opposite the first inner side wall 213, and a third sub-set of the plurality of the openings of the housing 210 may be on an inner longitudinal wall 215 (see FIG. 2B) (e.g. portion of a partitioning formation) extending between the first inner side wall 213 and the second inner side wall 214. Accordingly, according to various embodiments, at least one of the plurality of the openings (e.g. the first sub-set of the plurality of the openings) of the housing 210 and the auxiliary air vent 206 along the first lateral side wall 220c may be aligned with each other (e.g. directly aligned along a straight line or axis, or a hole axis of each of the first sub-set of the plurality of the openings of the housing 210 may be parallel or substantially parallel with a hole axis of the auxiliary air vent 206). At least another of the plurality of the openings (e.g. the second sub-set of the plurality of the openings) of the housing 210 may be aligned (e.g. substantially aligned) or in register with the primary air vent 205. At least yet another of the plurality of the openings (e.g. the third sub-set of the plurality of the openings) of the housing 210 and the further auxiliary air vent 207 along the second lateral side wall 220 may be aligned with each other.

With reference to FIG. 2A, according to various embodiments, the portable electronic device 200 may include the fan carriage module 270 detachably received within or in the module bay portion 240. According to various embodiments, the fan carriage module 270 may include a plurality of auxiliary fan units 271 within a casing of the fan carriage module 270. According to various embodiments, the casing of the fan carriage module 270 may include a plurality of module-carriage-primary-apertures and a plurality of module-carriage-secondary-apertures. According to various embodiments, when the fan carriage module 270 is detachably received within the module bay portion 240, (i) a first sub-set of the plurality of module-carriage-primary-apertures may be aligned or in register with the first sub-set of openings, (ii) a second sub-set of the plurality of module-carriage-primary-apertures may be aligned or in register with the second sub-set of openings, and (iii) a third sub-set of the plurality of module-carriage-primary-apertures may be aligned or in register with the third sub-set of openings.

As shown, the plurality of auxiliary fan units 271 may include, but is not limited to, 5 auxiliary fan units 271. By way of example, the plurality of auxiliary fan units 271 may include (i) a first sub-set of 1 auxiliary fan unit 271, (ii) a second sub-set of 1 (e.g. 1 other) auxiliary fan unit 271, and (iii) a third sub-set of 3 (e.g. 3 other) auxiliary fan units 271. As shown, the first sub-set of the plurality of auxiliary fan units 271 may be arranged in a manner such that its pressure side may face or be directed towards or in register with the auxiliary air vent 206 along the first lateral side wall 220c (i.e. the second segment of the border 220) and its suction side facing or directed towards or in register with a first sub-set of the plurality of module-carriage-secondary-apertures (e.g. on a base portion of the fan carriage module 270), i.e. when the fan carriage module 270 is received within the module bay portion 240. The second sub-set of the plurality of auxiliary fan units 271 may be arranged in a manner such that its pressure side may face or be directed towards or in register with the further auxiliary air vent 207 along the second lateral side wall 220 (i.e. the third segment of the border 220) and its suction side facing or directed towards or in register with a second sub-set of the plurality of module-carriage-secondary-apertures (e.g. on the base portion of the fan carriage module 270). The third sub-set of the plurality of auxiliary fan units 271 may be arranged in a manner such that its pressure side may face or be directed towards or in register with the inner longitudinal wall 215 (see FIG. 2B). As shown, the inner longitudinal wall 215 may be adjacent or alongside the thermal transfer body 251 and/or the heat-generating component. Hence, the third sub-set of the plurality of auxiliary fan units 271 may be arranged with its pressure side facing the thermal transfer body 251 and/or the heat-generating component. The suction sides of the third sub-set of the plurality of auxiliary fan units 271 may be facing or directed towards or in register with a third sub-set of the plurality of module-carriage-secondary-apertures (e.g. on the base portion of the fan carriage module 270). According to various embodiments, the pressure side and the suction side of each auxiliary fan unit 271 may be, but is not limited to being, perpendicular (e.g. substantially perpendicular) sides to each other.

According to various embodiments, the plurality of auxiliary fan units 271 (e.g. the first sub-set of the plurality of auxiliary fan units 271, the second sub-set of the plurality of auxiliary fan units 271, and the third sub-set of auxiliary fan units 271) may be individually controllable, for example, via a software or application running on the portable electronic device 200 and/or an electronic component (e.g. keyboard, and/or mouse, processor, etc. housed in the component enclosure portion 230). Accordingly, as an example, with reference to FIG. 2C, a user may selectively control the second sub-set of the plurality of auxiliary fan units 271 (i.e. the auxiliary fan unit 271 with its pressure side facing or configured to direct air towards the further auxiliary air vent 207 on a left side/second lateral side wall 220d of the housing 210, i.e. when viewed from the top view) to be in a “non-operational” mode, while the first sub-set of the plurality of auxiliary fan units 271 and the third sub-set of the plurality of auxiliary fan units 271 may be in an “operational” mode, i.e. when the fan carriage module 270 is received within the module bay portion 240. This may prevent or reduce an amount of hot/heated air from exiting the further auxiliary air vent 207 on a left side/second lateral side wall 220d of the housing 210 (i.e. when viewed from the top view) and onto a user's hand (e.g. when the user is left-handed/is using a mouse device on the left side of the housing 210). As another example, the user may selectively control only first sub-set of the plurality of auxiliary fan units 271 to be in the “non-operational” mode. As yet another example, the user may selectively control only the third sub-set of the plurality of auxiliary fan units 271 to be in the “operational” mode. The third sub-set of the plurality of auxiliary fan units 271 when in the “operational” mode may draw in air (e.g. cool/cooler air surrounding the portable electronic device 200) via the at least one module-carriage-secondary-aperture on of the casing of the fan carriage module 270 and (e.g. thereafter) push or direct the air into the component enclosure portion 230 (e.g. to cool at least the heat-generating component and/or the heat-dissipation arrangement 250). The air (e.g. heated air) may then exit the housing 210 (e.g. the component enclosure portion 230 of the housing 210) via any one or more or all of the primary air vent 205, the auxiliary air vent 206, and/or the further auxiliary air vent 207. According to various embodiments, the air (e.g. heated air) may also mix with cool/cooler air entering the housing 210 (e.g. the component enclosure portion 230 of the housing 210) via the at least one primary air inlet port (e.g. when air is being drawn into the component enclosure portion 230 of the housing 210 via the at least one air inlet port), before the air mixture exits one or more or all of the primary air vent 205, the auxiliary air vent 206, and/or the further auxiliary air vent 207. As yet another example, the user may selectively control all of the first sub-set of the plurality of auxiliary fan units 271, the second sub-set of the plurality of auxiliary fan units 271, and the third sub-set of auxiliary fan units 271 to be in the “operational” mode (e.g. for the portable electronic device 200 or the Central Processing Unit, the Graphics Processing Unit, etc., to operate at maximum performance/level/capacity).

FIG. 2C shows a schematic top view of the portable electronic device 200 of FIG. 2A, according to various embodiments.

According to various embodiments, with reference to FIG. 2C, the portable electronic device 200 may include a keyboard assembly 291 (e.g. keyboard) disposed within the component enclosure portion 230 of the housing 210 (e.g. within the main section 230c of the component enclosure portion 230). The keyboard assembly 291 may be stacked over any one or more or all of the heat-generating component and/or the heat-dissipation arrangement 250 (e.g. at least the thermal transfer body 251) and/or the at least one primary fan unit 260 (e.g. when the portable electronic device 200 includes the at least one primary fan unit 260). According to various embodiments, the keyboard assembly 291 may be aligned (e.g. substantially aligned) with the at least one opening connecting the module bay portion 240 and the component enclosure portion 230 (e.g. such that hole axis(es) of the at least one opening may be extending in a direction towards the keyboard assembly 291). Accordingly, when the fan carriage module 270 is received within the module bay portion 240, air circulated by the plurality of auxiliary fan units 271 (e.g. at least the third sub-set of the plurality of auxiliary fan units 271) within the fan carriage module 270 may reach or pass the keyboard assembly 291 (e.g. a base of the keyboard assembly 291) to keep the keyboard assembly 291 cool or at room temperature. As shown, the auxiliary thermal conveyance duct 253 and/or further auxiliary thermal conveyance duct 254 may be extending in a direction away from the keyboard assembly 291. As such, the auxiliary thermal conveyance duct 253 and/or further auxiliary thermal conveyance duct 254 may help or contribute to dissipating heat away from a region where the keyboard assembly 291 may be disposed or located.

According to various embodiments, the portable electronic device 200 may include (e.g. further include) a display 292 (e.g. monitor, screen, etc.) movably attached to the housing 210. For example, as shown, the display 292 may be hingedly connected to the housing 210 at the first longitudinal side wall 220a (i.e. first segment of the border 220) of the housing 210.

Various embodiments may thus provide a portable electronic device which may be capable of directing heat away from one or more internal components (e.g. heat-generating component) of the portable electronic device.

In particular, the portable electronic device of the various embodiments may be capable of directing the heat from the one or more internal components out of the portable electronic device.

Accordingly, the portable electronic device may be capable of running at a high capacity and/or for long periods of time while mitigating or minimizing any overheating issues.

Moreover, the portable electronic device of the various embodiments may include a hollow socket defining a receptacle space (i.e. modular bay portion). The modular bay portion (or hollow socket or receptacle space) may interchangeably receive part of its cooling system (e.g. fan carriage module) or a portable battery (e.g. power source module), thereby enabling the portable electronic device to be compact-sized.

While the disclosure has been particularly shown and described with reference to specific embodiments, it should be understood by those skilled in the art that various changes, modification, variation in form and detail may be made therein without departing from the scope of the present disclosure as defined by the appended claims. The scope of the present disclosure is thus indicated by the appended claims and all changes which come within the meaning and range of equivalency of the claims are therefore intended to be embraced.

1. A portable electronic device comprising:
a housing partitioned into a component enclosure portion and a module bay portion, the housing comprising a border surrounding the component enclosure portion and the module bay portion;
a heat-generating component disposed within the component enclosure portion of the housing; and
a heat-dissipation arrangement disposed within the component enclosure portion of the housing, the heat-dissipation arrangement comprising
a thermal transfer body in thermal contact with the heat-generating component,
a primary thermal conveyance duct extending from the thermal transfer body with a portion of the primary thermal conveyance duct running alongside an edge of the component enclosure portion away from the module bay portion, wherein the housing comprises at least one primary air vent along a first segment of the border of the housing corresponding to said edge of the component enclosure portion, and
an auxiliary thermal conveyance duct extending from the thermal transfer body with a portion of the auxiliary thermal conveyance duct lining a section of the component enclosure portion bordering a first edge of the module bay portion, wherein the housing comprises an auxiliary air vent along a second segment of the border of the housing corresponding to an edge of the section of the component enclosure portion opposite the first edge of the module bay portion in a manner such that the portion of the auxiliary thermal conveyance duct lies between the first edge of the module bay portion and the auxiliary air vent along the second segment of the border of the housing.

2. The portable electronic device of claim 1,
wherein the first segment of the border comprises a portion of a first side wall of the housing that is opposite the module bay portion.

3. The portable electronic device of claim 2,
wherein the second segment of the border comprises a portion of a second side wall of the housing that is substantially perpendicular to the first side wall; and
wherein the auxiliary air vent is along a distal end region of the portion of the second side wall with respect to the first side wall.

4. The portable electronic device of claim 1, further comprising:
at least one primary fan unit disposed within the component enclosure portion,
wherein the housing further comprises at least one primary air inlet port at the component enclosure portion;
wherein the primary fan unit is disposed in a manner so as to be capable of drawing in air via the at least one primary air inlet port and directing the air toward the at least one primary air vent;
wherein the portion of the primary thermal conveyance duct lies between the at least one primary fan unit and the at least one primary air vent.

5. The portable electronic device of claim 4,
wherein the at least one primary air inlet port is at a segment of a base of the housing.

6. The portable electronic device of claim 1,
wherein the heat-dissipation arrangement further comprises a further auxiliary thermal conveyance duct extending from the thermal transfer body with a portion of the further auxiliary thermal conveyance duct lining a further section of the component enclosure portion bordering a second edge of the module bay portion that is opposite the first edge of the module bay portion, wherein the module bay portion is interposed between the section and the further section of the component enclosure portion,
wherein the housing further comprises a further auxiliary air vent along a third segment of the border of the housing corresponding to an edge of the further section of the component enclosure portion opposite the second edge of the module bay portion in a manner such that the portion of the further auxiliary thermal conveyance duct lies between the second edge of the module bay portion and the further auxiliary air vent along the third segment of the border of the housing.

7. The portable electronic device of claim 1,
wherein the housing further comprises at least one opening fluidly connecting an interior space of the component enclosure portion and a receptacle space of the module bay portion.

8. The portable electronic device of claim 7,
wherein the housing comprises a plurality of the openings;
wherein a first sub-set of the plurality of the openings is along the first edge of the module bay portion opposite the auxiliary air vent; and
wherein a second sub-set of the plurality of the openings is along an edge of the module bay portion that is substantially perpendicular to the first edge of the module bay portion.

9. The portable electronic device of claim 8, further comprising:
a fan carriage module comprising a plurality of auxiliary fan units housed within a casing of the fan carriage module, wherein the fan carriage module is removably received in the receptacle space of the module bay portion.

10. The portable electronic device of claim 9,
wherein the fan carriage module comprises at least one module-carriage-primary-aperture and at least one module-carriage-secondary-aperture in the casing;
wherein, with the fan carriage module fitted in the receptacle space of the module bay portion, (i) the at least one module-carriage-primary-aperture of the fan carriage module is aligned with at least one of the plurality of the openings of the housing and (ii) the plurality of auxiliary fan units of the fan carriage module are capable of drawing air via the at least one module-carriage-secondary-aperture of the casing of the fan carriage module and directing the air through the at least one module-carriage-primary-aperture of the fan carriage module and the at least one of the plurality of the openings of the housing into the interior space of the component enclosure portion of the housing.

11. The portable electronic device of claim 9,
wherein the fan carriage module comprises a plurality of module-carriage-primary-apertures and at least one module-carriage-secondary-aperture in the casing;
wherein, with the fan carriage module fitted in the receptacle space of the module bay portion, a first sub-set of the plurality of module-carriage-primary-apertures of the fan carriage module is respectively aligned with the first sub-set of the plurality of the openings of the housing and a second sub-set of the plurality of module-carriage-primary-apertures of the fan carriage module is respectively aligned with the second sub-set of the plurality of the openings of the housing,
wherein the plurality of auxiliary fan units of the fan carriage module are capable of drawing air via the at least one module-carriage-secondary-aperture of the casing of the fan carriage module and directing the air through the plurality of the module-carriage-primary-apertures of the fan carriage module and the plurality of the openings of the housing into the interior space of the component enclosure portion of the housing.

12. The portable electronic device of claim 9,
wherein the plurality of auxiliary fan units of the fan carriage module are individually controllable.

13. A portable electronic device comprising:
a housing partitioned into a component enclosure portion for housing an electronic component and a module bay portion configured to removably receive a module, the housing comprising a border surrounding the component enclosure portion and the module bay portion,
wherein the housing comprises at least one air vent along a segment of the border of the housing corresponding to an edge of the component enclosure portion opposite an edge of the module bay portion,
wherein the housing comprises a partitioning formation serving as a boundary between the component enclosure portion and the module bay portion,
wherein the housing comprises a plurality of openings at the partitioning formation for air transfer between the component enclosure portion and the module bay portion, wherein at least one of the plurality of the openings is aligned with the at least one air vent; and
a power connection arrangement at the partitioning formation, wherein the power connection arrangement is connectable to the module for power transfer between the electronic component in the component enclosure portion and the module when the module is removably received in the module bay portion.

14. The portable electronic device of claim 13,
wherein the module comprises a power source module or a fan carriage module,
wherein the power source module and the fan carriage module is interchangeable with one another such that either may be removably received in the module bay portion at any one time,
wherein the power connection arrangement is configured to be connectable to the power source module when the power source module is removably received in the module bay portion and connectable to the fan carriage module when the fan carriage module is removably received in the module bay portion.

15. The portable electronic device of claim 14, further comprising:
the power source module removably received in the module bay portion,
wherein, with the power source module fitted in the module bay portion, the power source module is configured to supply power to the electronic component in the component enclosure portion via the power connection arrangement.

16. The portable electronic device of claim 14, further comprising:
the fan carriage module removably received in the module bay portion,
wherein the fan carriage module comprises a plurality of fan units housed within a casing of the fan carriage module;
wherein the fan carriage module comprises at least one module-carriage-primary-aperture and at least one module-carriage-secondary-aperture in the casing;
wherein, with the fan carriage module fitted in the module bay portion, (i) the at least one module-carriage-primary-aperture of the fan carriage module is aligned with one or more of the plurality of the openings of the housing and (ii) the plurality of fan units of the fan carriage module are capable of drawing air via the at least one module-carriage-secondary-aperture of the casing of the fan carriage module and directing the air through the at least one module-carriage-primary-aperture of the fan carriage module and the one or more of the plurality of the openings of the housing into the component enclosure portion of the housing;
wherein, with the fan carriage module fitted in the module bay portion, the fan carriage module is configured to draw power from the electronic component in the component enclosure portion via the power connection arrangement.

17. The portable electronic device of claim 16,
wherein, with the fan carriage module fitted in the module bay portion, the plurality of fan units of the fan carriage module are individually controllable.

18. The portable electronic device of claim 13,
wherein the first sub-set of the plurality of the openings are at a first segment of the partitioning formation and a second sub-set of the plurality of the openings are at a second segment of the partitioning formation that is adjacent to the first segment;
wherein the first segment and the second segment of the partitioning formation are non-parallel to each other.

19. The portable electronic device of claim 18,
wherein the first segment and the second segment of the partitioning formation are substantially perpendicular to each other.

20. The portable electronic device of claim 18,
wherein a third sub-set of the plurality of the openings are at a third segment of the partitioning formation adjacent to the second segment of the partitioning formation such that the second segment lies between the first segment and the third segment of the partitioning formation;
wherein the first segment and the third segment of the partitioning formation are substantially parallel with each other.
